(19) United States
(12) Patent Application Publication
(10) Pub. No.: US 2015/0321062 A1
(43) Pub. Date: Nov. 12, 2015

(54) STRIKE ZONE DETECTION DEVICE

(71) Applicant: Lauren Tyndall, Chicago, IL (US)

(72) Inventor: Lauren Tyndall, Chicago, IL (US)

(21) Appl. No.: 14/270,533

(22) Filed: May 6, 2014

(51) Int. Cl. A63B 69/00; F16M 11/28

(52) U.S. Cl. CPC A63B 69/0002; F16M 11/28; A63B 2069/0006

(57) ABSTRACT

The present invention provides a sports training device having at least two stanchions, wherein the stanchions are spaced a horizontal distance apart from each other and wherein the stanchions telescope vertically and are portable; a plurality of horizontal dividers, wherein the plurality of horizontal dividers span between the at least two stanchions; and a plurality of vertical dividers, wherein the plurality of vertical dividers depend from at least one of the plurality of horizontal dividers and wherein the plurality of horizontal dividers and the plurality of vertical dividers overlap to define a plurality of zones. Also provided is an embodiment in which lasers are used as the horizontal and vertical dividers.

### BACKGROUND OF THE INVENTION

1. Field of the Invention

This invention is directed to a training device for pitchers such that the pitcher can receive either visual or auditory feedback or both visual and auditory feedback as to whether a pitch has passed through a desired strike zone.

2. Background of the Invention

All athletes require practice in order to perform at their highest level. Typically, practice comes in the form or repetitive drills that teach muscle memory, and frequently, such drills incorporate the use of a training aid.

For pitchers, the best practice is often in the form of repeatedly throwing to a specific area: one which would result in a strike if the batter fails to make contact with the ball, i.e. the strike zone. Many pitching aids are capable of providing a simulated strike zone. However, as pitchers increase in skill level, just throwing into the strike zone is not good enough; instead, a pitcher must be able to hit specific areas within or around the strike zone. For instance, pitchers frequently make pitches outside the zone in hopes that a batter will chase the pitch, producing a swinging miss or a poorly struck ball. Also, as strikes are called by a human umpire, a pitcher must be able to practice adjusting to larger or smaller strike zones. Therefore, a pitching aid should be able to train these various aspects inherent to pitching.

Most pitching aids that feature a simulated strike zone contain a backstop to catch pitched balls. Some even contain ball-return features. However, additional benefits could be realized if the pitching aid allowed for the simultaneous training of a catcher. In that way, not only could the pitcher work on hitting locations in the strike zone, but the catcher could also practice catching different pitches in different locations and develop a rapport with the pitcher. It would be valuable practice if the catcher was able to visually determine where a pitch crosses the strike zone in relation to where the catcher sets up and where the pitch breaks from.

Many pitching aids are bulky, heavy, or immovable. They are not designed for easy set-up or teardown, and many are incapable of being transported by a single person if they are transportable at all. Further, most pitching aids can only be used to practice pitching. Additional benefit could be had if the pitching aid was modifiable such that it could be used to practice other sports.

Therefore, a need exists in the art for a pitching aid in which the pitching target simulates a strike zone and can be manipulated to provide specific smaller zones within or near the strike zone. Moreover, a need exists in the art for a pitching aid that features “pitch-through” ability, such that the pitching aid can be used by both a pitcher and a catcher simultaneously. Finally, a need exists in the art for a pitching aid that accomplishes the above functions while still being lightweight and portable.

### SUMMARY OF THE INVENTION

An object of the present invention is to solve the foregoing problems associated with prior art pitching aids.

Another object of the present invention is to provide a pitching trainer in which the strike zone is customizable such that a pitcher can focus on specific locations in or around the strike zone. A feature of the present invention is that it is comprised of a number of horizontal and vertical dividers that are capable of movement relative to one another. Additionally, each horizontal and vertical divider can move independently of the other horizontal and vertical dividers. An advantage of the present invention is that the horizontal and vertical dividers define adjustable zones within the strike zone to hone a pitcher's aim at specific areas of the strike zone.

A further object of the present invention is to provide a pitching trainer that a pitcher and catcher can use together. A feature of the present invention is that the target zones are defined by thin strips of material that do not impede a ball in flight; in other words, there are no hard objects off of which a ball could deflect while going through the strike zone, frustrating the catcher's ability to catch a pitched ball. An advantage of the present invention is that both a pitcher and catcher can sharpen their individual skills while at the same time developing a rapport with one another.

Still another object of the present invention is to provide a pitching trainer with enhanced portability. A feature of the present invention is that the components, such as the telescoping stanchion poles and the folding stanchion base, are lightweight and collapsible. The strike zone grid is also collapsible as the strings can be removed from the stanchion and coiled. The grid is also able to be rolled up since it is just removable strings, also the base and weight are able to separate from each other, the base is what I am referring to as the interface and legs together. An advantage of the present invention is that the user can easily and conveniently set up the device on a ball diamond, in the backyard, or at any other type of practice facility.

Still another object of the present invention is to provide a sports training device that can be used in a variety of situations to enhance the user's accuracy. A feature of the present invention is that the height and width of the device are fully customizable based on the extension of the telescoping poles, the spacing of the stanchions, and the amount of dividing material used. Another feature of the present invention is that the number of horizontal and vertical dividers can be varied to provide a variable number and size of zones. An advantage of the present invention is that it lends itself to use in any sport in which a player aims a playing object at a target or in which a player can benefit from practicing such a maneuver.

The present invention provides a sports training device, comprising at least two stanchions, wherein the stanchions are spaced a horizontal distance apart from each other and wherein the stanchions telescope vertically and are portable; a plurality of horizontal dividers, wherein the plurality of horizontal dividers span between the at least two stanchions; and a plurality of vertical dividers, wherein the plurality of vertical dividers depend from at least one of the plurality of horizontal dividers and wherein the plurality of horizontal dividers and the plurality of vertical dividers overlap to define a plurality of zones.

Also provided is a strike zone detection device, comprising a first vertical support member, wherein the first vertical support member contains a plurality of horizontally directed laser sensing devices; a second vertical support member, wherein the second vertical support member contains a plurality of reflectors; an upper horizontal crosspiece, wherein the upper horizontal crosspiece contains a plurality of vertically directed laser sensing devices; and a lower horizontal crosspiece, wherein the lower horizontal crosspiece contains a plurality of reflectors, and wherein the horizontally and vertically directed lasers intersect to define a strike zone.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 depicts a first embodiment of the present invention as used for softball pitching training;

FIG. 2A depicts the pitching trainer of FIG. 1 taken along line 2-2 in accordance with the features of the present invention;

FIG. 2B depicts an embodiment of the pitching trainer with variable interval vertical dividers in accordance with the features of the present invention;

FIG. 3 is a detail view of the stanchion base taken along;

FIG. 4A depicts another embodiment of the stanchion base with removable weights;

FIG. 4B depicts a third embodiment of the stanchion base with removable weights;

FIGS. 5A and B depict an embodiment of the present invention in which the legs of the base are attached via a slip joint;

FIG. 5C depicts a pin used in the embodiment of FIG. 5B;

FIG. 5D depicts an embodiment of the present invention of FIG. 5A.

FIGS. 6A-I depict alternative embodiments of the stanchion base;

FIG. 7A depicts a second embodiment of the present invention;

FIG. 7B depicts a detailed, sectional view of the base of FIG. 7A;

FIG. 8A depicts a detail view of the horizontal divider of FIG. 7A;

FIGS. 8B-C depict alternate embodiments of the horizontal divider;

FIG. 9 depicts a third embodiment of the present invention in which lasers are utilized;

FIG. 10 depicts the embodiment of FIG. 9 in exploded view;

FIG. 11 depicts a modified version of the second embodiment; and

FIG. 12 depicts the embodiment of FIG. 9 in operation.

### DETAILED DESCRIPTION OF THE INVENTION

The foregoing summary, as well as the following detailed description of certain embodiments of the present invention, will be better understood when read in conjunction with the appended drawings.

As used herein, an element recited in the singular and preceded with the word “a” or “an” should be understood as not excluding plural said elements, unless such exclusion is explicitly stated. Furthermore, the references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

### String Embodiment

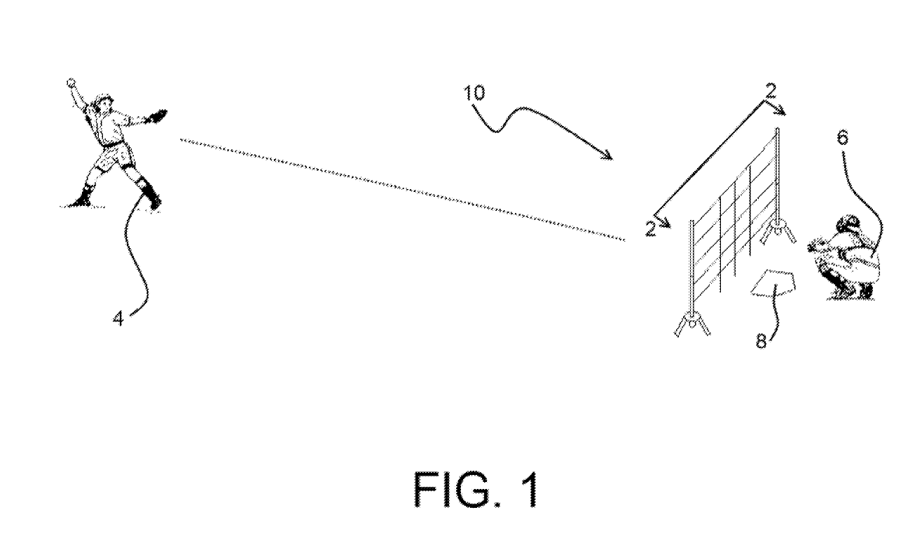

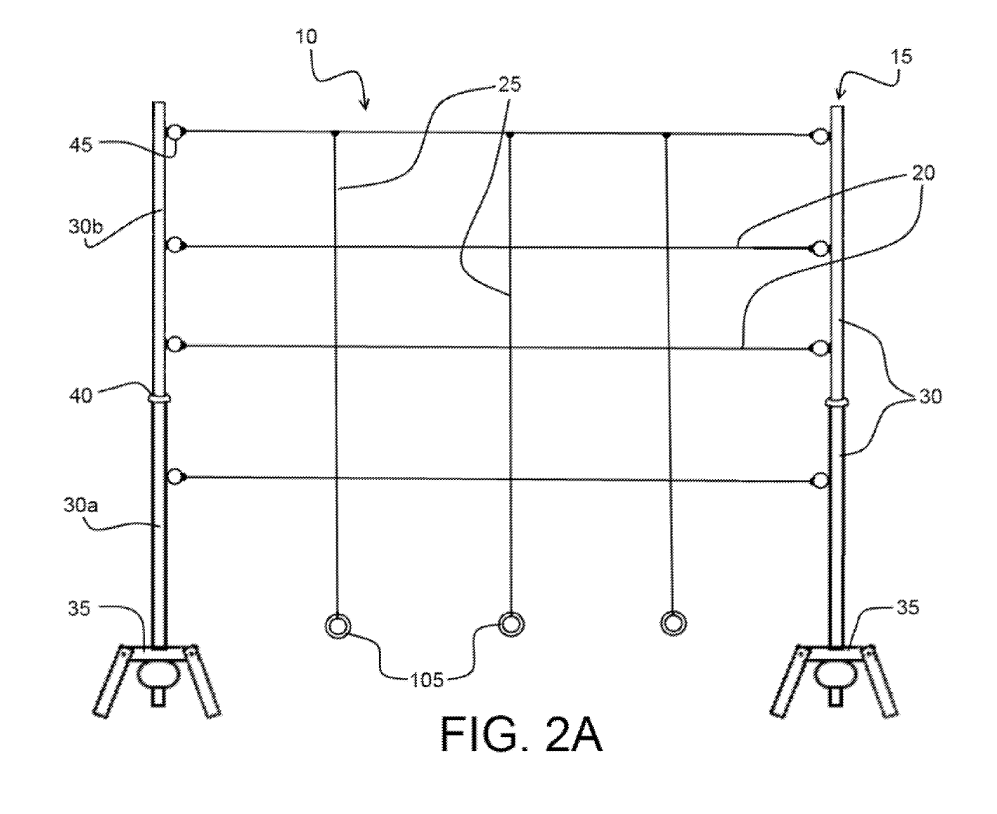

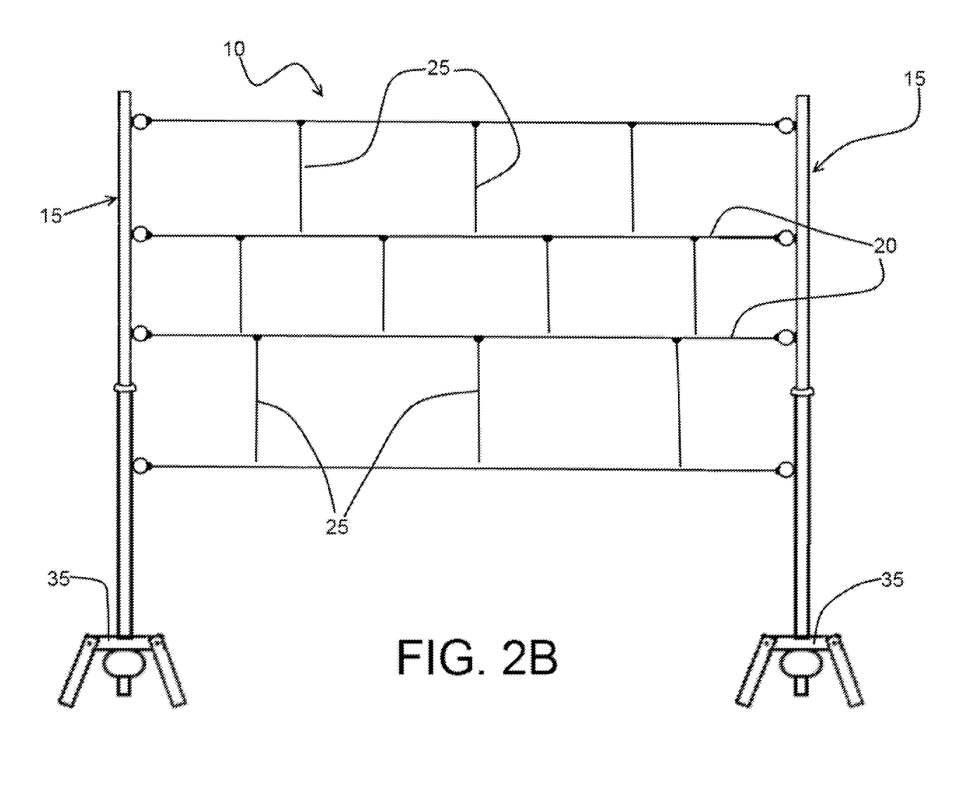

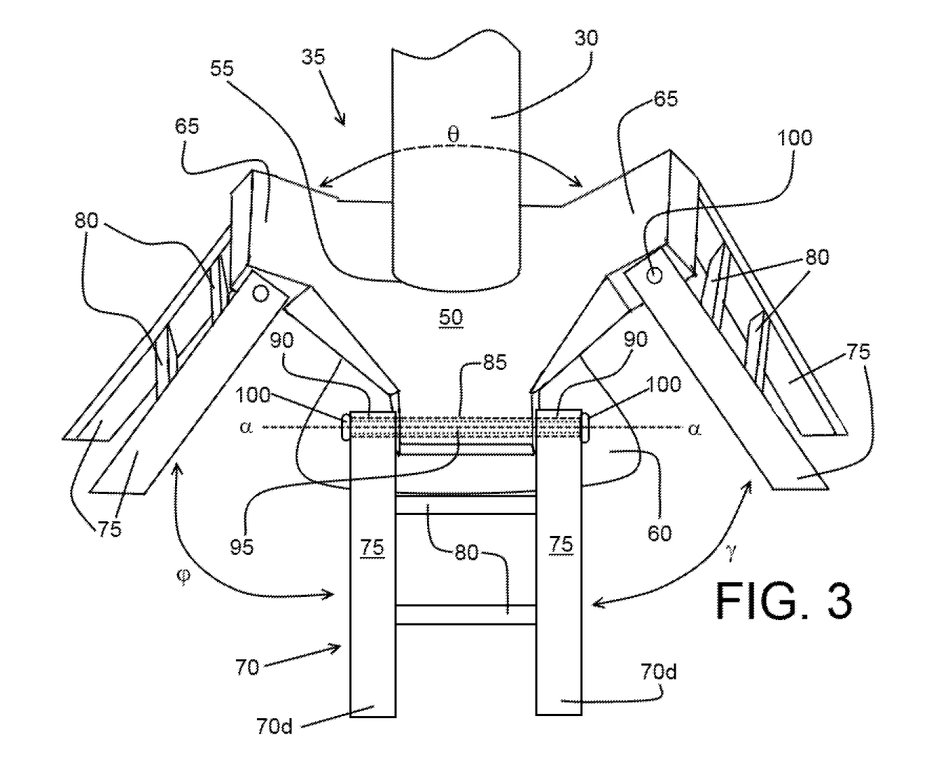

As can be seen in FIG. 1, the present invention is directed to a pitching trainer 10 that allows a pitcher 4 and catcher 6 to detect the area of the strike zone that a pitch goes through. Briefly, according to FIG. 2A, the pitching trainer 10 is comprised of two stanchions 15, a number of horizontal dividers 20, and a number of vertical dividers 25. The horizontal dividers 20 span between the first stanchion 15a and the second stanchion 15b. The vertical dividers 25 depend from the top horizontal divider 20 in such a way that the overlap of the horizontal dividers 20 and the vertical dividers 25 define a multitude of zones.

FIG. 1 demonstrates that the pitching trainer 10 is designed to be placed between a pitcher 4 and a catcher 6. While FIG. 1 depicts softball players, the invention can be used for any sport in which a player directs a playing object at a specific target. For example, the device can be used to train players in softball, baseball, soccer, lacrosse, football, hockey, cricket, and basketball to name a few. If the players are practicing softball or baseball, the pitching trainer 10 is preferably placed just in front of or over home plate 8. Depending on the sport being played and the desired type of practice, the present invention may be placed closer to either player. Further, the invention could optionally be placed in front of a goal, wall, fence, or other type of backstop.

Referring now to FIG. 2A, the stanchions 15 are spatially disposed of one another. In one embodiment, each stanchion 15 is alike, and a description of one is representative of the other. Generally, each stanchion 15 is comprised of a pole 30 and a base 35. In some embodiments, the pole 30 is telescoping. As depicted in FIG. 2A, the pole 30 consists of a first telescoping portion 30a and a second telescoping portion 30b; however, additional telescoping portions are envisioned. The telescoping action is typically accomplished by nesting a pole with a smaller outside diameter within a pole with a larger inside diameter. Depending on the thickness of the outermost pole and the wall thickness of each pole, the number of telescoping portions can vary greatly. As additional pole length is needed, the inner poles can be extended and locked into place. A variety of locking means 40 can be employed to keep the poles in their extended position, including but not limited to frictionally engaging gaskets, threaded fasteners, lever fasteners, and spring loaded buttons with corresponding holes. As shown in FIG. 2A, the locking means is a gasket 40 between two telescoping portions of the pole 30. Additionally, the telescoping portions of the pole 30 can be of the same diameter, and additional portions can be added by using a variety of permanent or removable pipe unions or connectors, such as a thread and nut assembly, and other secure removable connection means.

The pole 30 can be made from a variety of suitable materials including metals, composites, plastics, or wood. The poles 30 are typically spaced six to ten feet apart so as to avoid repeated hits from pitched balls; although, the poles could be spaced wider apart based on the sport being practiced. However, the poles 30 are able to withstand occasional hits from pitched balls. Preferably, the poles 30 are made from a light weight yet durable material such as hardened alloys of aluminum or titanium, carbon fiber, polycarbonate, acrylonitrile butadiene styrene (ABS), or polyvinylchloride. Other materials are also suitable, such as borated aluminum. Stainless steel would provide good corrosion resistance in outdoor uses, but it would also cause the poles to weigh more. Wood, including bamboo, is used in some non-telescoping embodiments.

In one embodiment, along the length of the pole 30 located are a number of attachment points 45. The horizontal dividers 20 are mounted to the stanchion 15 at the attachment points 45. As depicted in FIG. 2A, the attachment points 45 are removable eyelets. The eyelets are removable so as to allow the second telescoping portion 30b of the pole 30 to be lowered into the first telescoping portion 30a. The eyelets are also removable so as to allow the user to move them vertically to different points along the length of the pole 30. Other attachment points 45 are easily envisioned, including an annular groove, hook screws, eyelet screws, magnetic attachments, pins and slots, and rings. In one embodiment, the attachment points 45 are excluded, and the horizontal dividers are attached directly to the pole 30. The horizontal dividers 20 can be tied to any of the above attachment points 45, or alternatively, the horizontal dividers 20 can be tied directly to the pole 30. In another embodiment, one pole 30 features a retractable reel on which to wind the horizontal divider 20. The opposing pole 30 features an eyelet, hook, slot, or other means to secure the horizontal divider 20. In this way, the horizontal divider can be conveniently reeled inside the pole for storage.

To aid in the location of the attachment points 45, in one embodiment, each pole 30 includes a series of notches to provide suitable locations to mount the attachment points 45 at regular intervals. In another embodiment, markers are painted, etched, or embossed on the poles 30.

While the embodiment shown in FIG. 2A features horizontal dividers 20 that are regularly spaced, resulting in a grid with substantially equal sized rectangles, given that the attachment points 45 can be placed arbitrary locations, the grid is irregular in other embodiments with different sized polygons throughout.

Referring to FIG. 3, one end of the pole 30 is connected to an interface 50. The pole 30 is attached to the interface 50 at joint 55. A variety of joints 55 are suitable to connect the pole 30 to the interface 50. For instance, the pole and interface can be joined by a threaded union; the pole could be integrally molded with the interface; the pole could snugly fit a slot with or without a gasket in the interface; the interface could feature a peg with a corresponding locking channel on the pole; the pole could be bolted to the interface, such as with a shoulder bolt trough the bottom of the interface; or the pole could slide through the interface and rest on the ground.

The interface 50 can be made of the same material as the pole 30 or a different material. The material should also be lightweight to increase portability and durable to withstand occasional hits by pitched balls.

In some embodiments, a weight 60 is attached to the interface 50, the pole 30, or an additional support extending from the interface 50 or pole 30. In one embodiment, the weight 60 is half of a dumbbell joined to the bottom of the interface 50. The weight 60 serves to steady the stanchion 15, especially when the stanchion 15 is struck by a pitch. The weight 60 can come in a variety of sizes, ranging from one pound to one hundred pounds if desired by the user. Preferably, in embodiments of the invention optimized for portability, the weight 60 is between three and ten pounds.

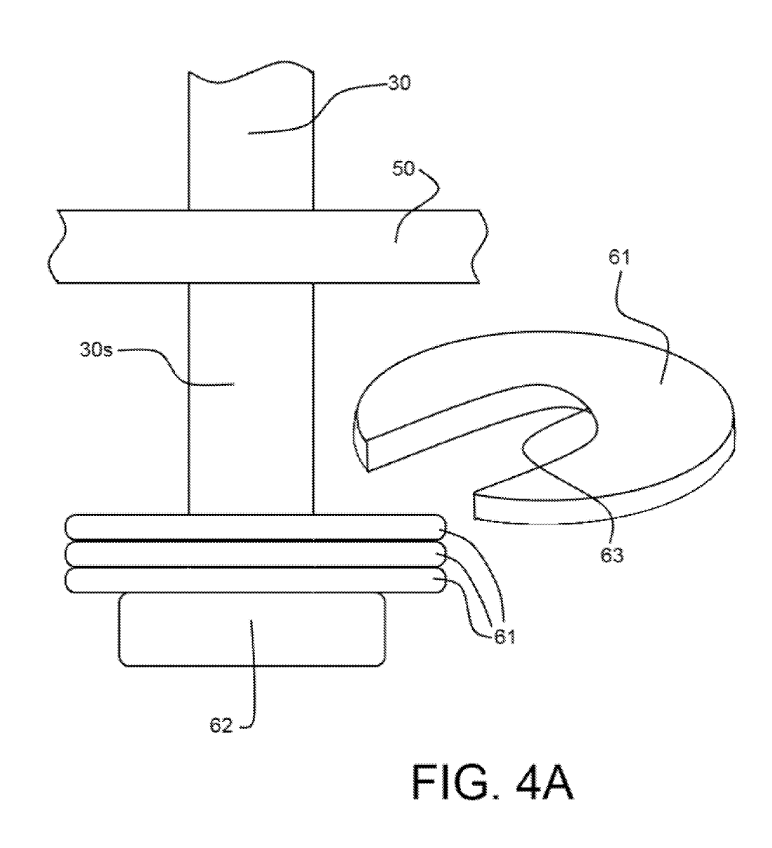

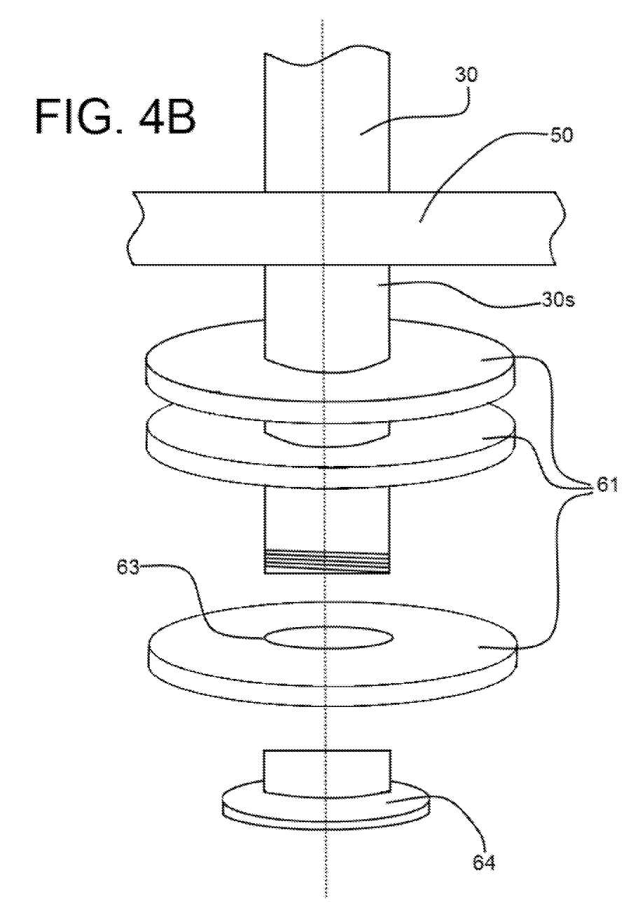

In other embodiments, the weight 60 is comprised of a multitude of removable weights 61. In these embodiments as shown in FIGS. 4A and 4B, a subportion 30s of the pole 30 extends through the interface 50. The subportion 30s can be a physical extension of the pole 30, an additional length of pole 30, or a part of the weight 60 added below the interface 50.

In FIG. 4A, a permanent weight 62 is integrally molded to the end of the subportion 30s. The permanent weight 62 functions as a base upon which the removable weights 61 rest. The removable weights 61 feature a slot 63. As shown in FIG. 4A, the slot 63 is a notch from the perimeter of the weight to the interior such that the notch allows the removable weight 61 to engage the subportion 30s. In this way, the removable weights 61 can easily be added or removed from the base 35. To secure the removable weights 61 on the subportion 30s, pins or grooves may be used to lock the removable weights 61 in place.

As shown in FIG. 4B, the subportion 30s features an end cap 64. The end cap 64 can optionally be weighted, but the primary purpose of the end cap 64 is to provide a secure base upon which the removable weights 61 rest. The end cap 64 can be attached to the pole via a male and female threaded connection, a sealing gasket, a pin and groove locking mechanism, or any other suitable means. When the end cap 64 is removed the removable weights 61 are slid onto the pole 30 via slot 63. In this instance, the slot 63 is an aperture at the center of the removable weight 61. When the desired amount of weight is added, the end cap 64 is replaced on the pole 30.

The individual removable weights 61 can be of any weight amount, but a weight of between one and ten pounds has been found to be sufficient for most outdoor applications. The number of removable weights 61 that can be added will vary depending on the size and thickness of the removable weights 61 and on how much space is provided between the end of the subportion 30s and the interface 50. In one embodiment, the removable weights 61 are made of a non-oxidizing material so as to be suitable for long term outdoor use. In another embodiment, the removable weights 61 are made of plastic or metal with a rubber coating.

Returning to FIG. 3, the interface 50 further features protrusions 65, which provide a location to mount the legs 70. In the embodiment as shown in FIG. 3, each leg 70 is comprised of two posts 75 and a number of crosspieces 80, with two crosspieces 80 shown in this embodiment. The crosspieces 80 provide structural support for the legs 70 and help prevent the posts 75 from bowing. An advantage of using two posts 75 in the leg 70 is that it provides multiple contact points on the ground, which helps to stabilize the base 35. Another advantage of the design is that it provides a good compromise between strength, weight, and material cost. Though the legs 70 of this embodiment feature two posts 75 and crosspieces 80, other designs are easily envisioned, including a design wherein the entire leg is a single piece. Further, only three legs 70 are depicted in FIG. 3, but more legs 70 could be used.

The legs 70 as depicted in FIG. 3 form a tripod for the base. As shown, each leg is separated from the other leg by an angle θ, φ, or γ. In one embodiment, θ, φ, and γ are equiangular. In a second embodiment, θ is 135°, φ is 135°, and γ is 90°. This spacing puts two legs pointing towards the strike zone, which helps to prevent the stanchions from tipping over if a pitched ball pulls hard on the horizontal or vertical dividers.

The legs 70 and crosspieces 80 can be made of the same material as the pole 30 or the interface 50, or they can be made of different materials. In one embodiment, the legs 70 and crosspieces 80 are made of different materials. In another embodiment, the materials are selected so as to add additional weight to the interface 50 to give the device additional stability.

The legs 70 are designed to fold and be adjustable so as to provide balance to the device in instances where the device is deployed on uneven surfaces. In one embodiment, the legs 70 are in hingeable communication to the protrusions 65. The components of the hinge joint are shown in FIG. 3. When deployed, the legs 70 are held in place by the intrinsic weight of the device, as well as by the weight 60 or removable weights 61 if included. If a weight 60 or removable weights 61 are utilized, preferably, they do not contact the ground. If the weight 60 or removable weights 61 do not contact the ground, the legs 70 are forced to support the weight of the device, which brings them into better contact with the ground. This increases the stability of the device.

The protrusion 65 features a first internal channel 85 along the axis α through the width of the protrusion 65. Each post 75 similarly features a second internal channel 90 along the axis α through the width of each post 75. A pin 95 extends through the first internal channel 85 and the second internal channel 90 to secure the leg 70 to the protrusion 65. To ensure the pin 95 does not slide loose of the internal channels, pinheads 100 are forged, stamped, welded, sanded, or screwed to the pin 95. The pin 95 should snugly fit the first internal channel 85, but the pin 95 should not be so snug as to prevent rotation about the axis α. In another embodiment, the pin 95 is glued into or integrally molded with the leg 70, and thus, the pin 95 would rotate with the leg 70 about the axis α.

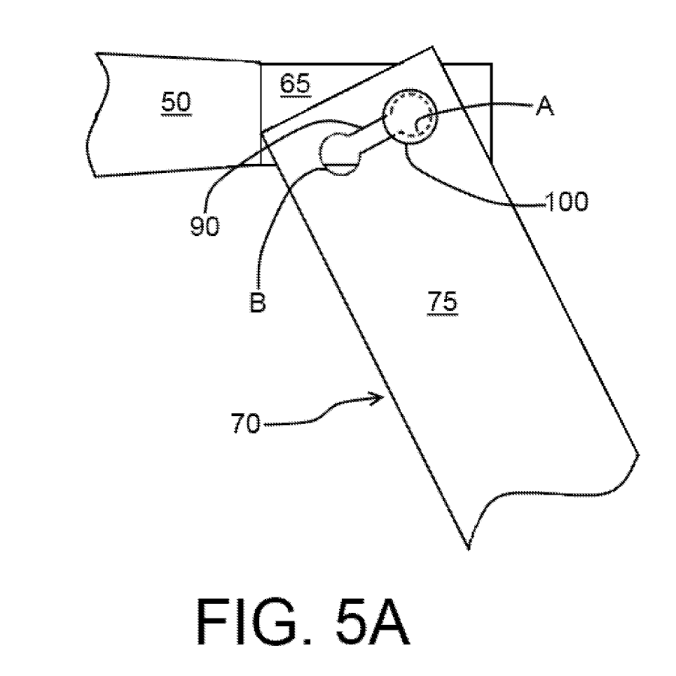

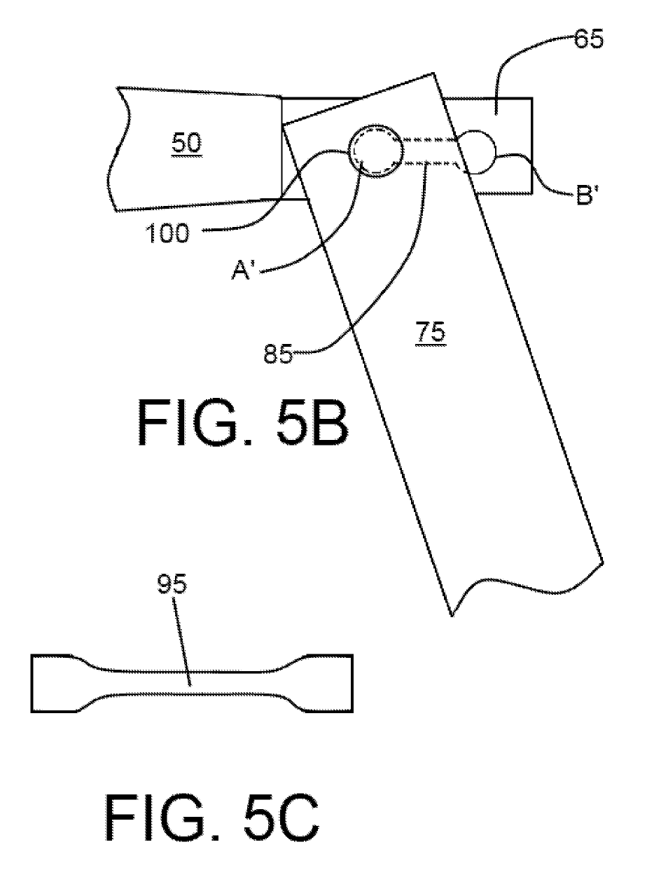

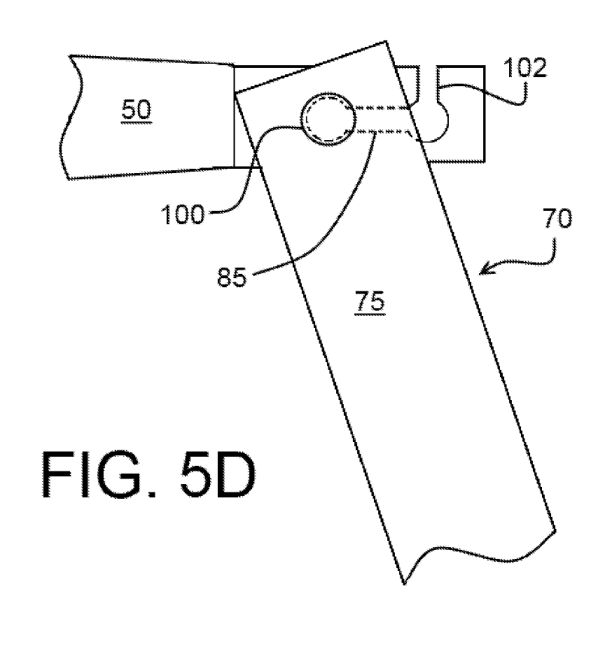

In another embodiment as can be seen in FIG. 5A, the second internal channels 90 on the legs 70 are slip joints. The slip joint channels 90 allow the pin 95 to slide between a first position A and a second position B. The advantage of using a slip joint is that it allows the leg 70 to rest against the interface 50 when the leg 70 is in the deployed position A. By resting the leg 70 against the interface 50, the stability of the stanchion is enhanced, and the leg 70 is prevented from over-rotating. Further, the user can quickly set up the stanchion 15 because the legs 70 will all contact the interface 50 at the same angle, ensuring proper alignment of the pole 30. When storing the stanchion 15, the leg 70 is slid to position B, allowing it to be folded upwards toward the pole 30.

Another variation of the slip joint is shown in FIG. 5B. The slip joint channel is formed into the first internal channel 85. The pin 95 is permanently attached to the second internal channels 90 on the legs 70. In this way, the posts 75 of the legs 70 slide and rotate together in the first internal channel 85. The pin slides from a first position A′ to a second position B′. When placed in position A′, this embodiment allows the legs 70 to rest against the interface 50, providing enhanced stability for the stanchion 15. For storing the device, the legs 70 are then moved to position B′ so that they can be folded up without contacting the interface 50. With the legs 70 in the upright position, they can be slid back to position A′ to compact the base 35 for storage. The pin 95 in this embodiment is shown in FIG. 5C. As can be seen in FIG. 5C, the pin 95 has an hourglass shape such that it can slide between position A′ and position B′. The pin 95 can be made of any suitable material, including metals, composites, plastics, or wood. In a preferred embodiment, the pin 95 is made of Nylon 6 or Nylon 6-6, which are both high strength, rigid polymers.

In still another embodiment as shown in FIG. 5D, the slip joint channel 85 features an exit channel 102. The exit channel 102 allows the leg 70 to be removed from the base 35 for storage or replacement.

In all of the embodiments, the hinge joint allows the legs 70 to be rotated about the axis α. Thus, the distal end 70d of the legs 70 can be rotated from first position proximal to the pole 30 to a second position proximal to the ground. In this way, the legs 70 of the base 50 can be deployed in the second position while the pitching trainer 10 is in use, and then the legs 70 can be folded into the first position to facilitate compact storage of the pitching trainer 10.

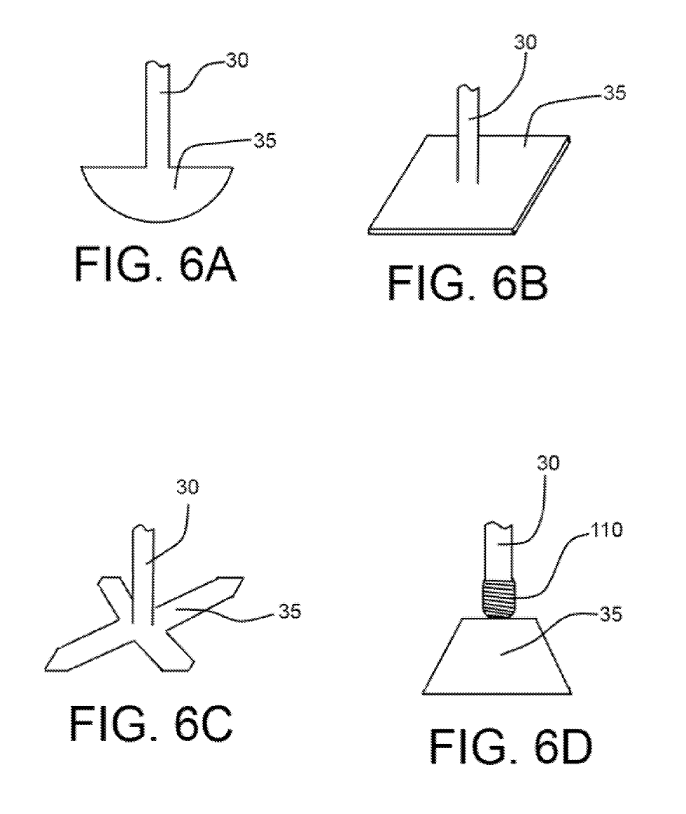

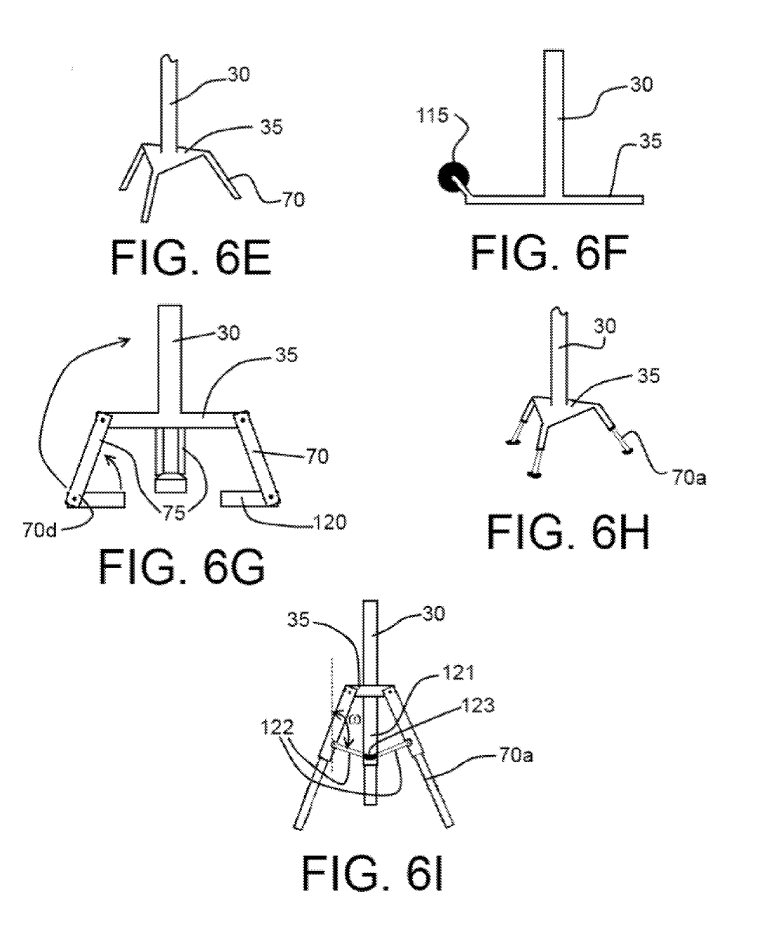

Other embodiments of the base 35 are shown in FIGS. 6A-E. FIG. 6A depicts a rounded bottom base. FIG. 6B depicts a square platform base. FIG. 6C depicts an “X” shaped base. FIG. 6D depicts a frustoconical base with a spring member 110 to allow for resiliency and return to an upright position should the pole be hit with a ball. In this embodiment, the pole 30 is in communication with the spring, and the spring allows the pole 30 to deflect upon impact, absorbing some of the energy of the impact. FIG. 6E depicts a simple tripod base in which the legs are fixed, i.e., they are not foldable like the legs 70 as depicted in FIGS. 1-3. The embodiment in FIG. 6E is suitable for use on even surfaces, such as indoor areas.

FIG. 6F depicts an embodiment similar to that shown in FIG. 6B, except one side of the base 35 features wheels 115. In this embodiment, the wheels 115 are angled upwardly when the base 35 is resting flat on the ground. When the user wants to move the base 35, she tips the base 35 towards the side with the wheels 115. The wheels 115 contact the ground and facilitate movement of the pitching trainer. Other embodiments featuring wheels 115 are easily envisioned, such as a base resting on three or four wheels 115 or a base resting on two wheels and further featuring a kickstand. Still other embodiments for a base not featuring wheels are easily envisioned.

FIG. 6G depicts a base with hingeable legs 70. On the distal end of the legs 70d, and additional hinge is placed. Instead of crosspieces 80 between the posts 75, there is a weighted block 120. The weighted block 120 folds down from between the posts 75 of the leg 70 and rests on the ground. Because the leg features two hinges, the weighted block 120 can be folded up between the posts 75, and then the entire leg 70 can be folded towards the pole 30 for storage.

FIG. 6H depicts a tripod base similar to that shown in FIG. 6E, but the legs 70 are telescoping. By incorporating telescoping legs 70, the base can be adjusted so as to be level on uneven ground. In making the base level, the stanchion is more stable. Otherwise, an uneven base could cause the pole to lean and tip over easier. Preferably, each leg 70 has a telescoping portion 70a that can be locked into place at any point between fully extended and fully retracted. Thus, a frictionally engaging gasket, locking clamp, or other similar device is used to maintain each leg in the desired position.

FIG. 6I depicts another tripod embodiment. In this embodiment, the tripod features a stabilizer bar 121 depending from the base 35. The legs 70 have at least one telescoping portion 70a. The legs 70 are joined to the stabilizer bar 121 via arms 122. The arms 122 are in hingeable communication with the legs 70 such that as the legs 70 are spread the angle ω of the arms 122 between the legs 70 and the stabilizer bar 121 goes from between about 0° when the legs 70 are not spread to about 115° when the legs 70 are fully spread. The arms 122 are also in hingeable communication with a ring 123 around the stabilizer bar 121. The ring 123 slides up and down the stabilizer bar 121 as the legs are spread and closed.

When the pitching trainer 10 is to be used, the stanchions 15 are placed in an upright position with the base 35 proximal to the ground. The legs 70 are deployed to the second position, and the distal ends 70d of the legs 70 contact the ground. The spacing of the stanchions 15 will depend on the type of training desired. For baseball and softball pitching, the stanchions 15 are spaced far enough apart such that the catcher's view of and ability to catch wide pitches is not obstructed. Thus, the stanchions might be spaced approximately ten feet apart with the center of the space located at the center of home plate. This spacing corresponds to the width of a regulation batter's box. However, larger or smaller spaces may be used as desired.

After the stanchions 15 are appropriately spaced by the user, the horizontal dividers 20 are strung between the stanchions 15. The horizontal dividers 20 are typically made of string, rope, yarn, elastic, or other such cords, strands, or braided fibers. The inventor has found 2 mm elastic cord to work well as the horizontal divider 20. Further, the horizontal divider 20 should be made of a highly visible material so that the pitcher and catcher can easily see whether and where the ball hit the horizontal divider 20. For this purpose, fluorescent colors have been found to work well. In one embodiment, the horizontal divider 20 contains one color on the side facing the pitcher and one color on the side facing the catcher. In that way, when a pitched ball catches a string, the opposite side featuring a second color is briefly exposed to the pitcher and catcher.

As depicted in FIGS. 1, 2A and 2B, the pitching trainer 10 has four horizontal dividers 20. However, the actual number of horizontal dividers 20 can be greater or lesser, depending on how many zones the user would like to achieve. Also as shown in FIGS. 1 and 2, the horizontal dividers 20 are roughly equally spaced apart. Again, the user can tailor the spacing of the horizontal dividers 20 on the pitching trainer 10 to suit her individual needs.

After placing the stanchions 15 and stringing the horizontal dividers 20, the vertical dividers 25 are attached. The vertical dividers 25 depend from one of the horizontal dividers 20. As depicted in FIGS. 1 and 2A, the vertical dividers 25 depend from the uppermost horizontal divider 20; nevertheless, the vertical dividers 25 can be made to depend from any of the horizontal dividers 20. For instance, as depicted in FIG. 2B, the vertical dividers 25 have a length corresponding to the vertical separation of the horizontal dividers 20. In this way, the vertical dividers 25 can be attached to the horizontal dividers 20 to provide irregular intervals between horizontal zones. As depicted in FIGS. 2A-2B, the vertical dividers 25 are tied to the horizontal divider 20. Other suitable means to attach the vertical dividers 25 to the horizontal dividers 20 include, but are not limited to, clips, hooks, and carabineers. Referring now to FIG. 2A, the vertical dividers 25 optionally feature hanging weights 105 that maintain a measure of tautness in the vertical dividers 25 when the pitching trainer 10 is used in windy conditions. The hanging weight 105 can be from an ounce to a pound. The inventor has found a nut or washer to be suitable as a hanging weight 105. Alternately, the vertical dividers 25 can be of such a length that they contact the ground, which will also help to stabilize them, or the vertical dividers 25 could be made of a heavy material. The vertical dividers 25 can be made of the same material as the horizontal dividers 20, or they can be made of a different material. Preferably, the vertical dividers 25 are made of a highly visible material, such as the fluorescent elastic cord mentioned above.

As shown in FIGS. 1 and 2A, the pitching trainer 10 features three vertical dividers 25, but more or less dividers may be used, according to the user's preference. As shown, the vertical dividers 25 are equally spaced apart, but the user can optionally space the vertical dividers at irregular intervals. Further, the user could forgo the use of the vertical dividers 25 altogether if so desired. Additionally, the user could use a single horizontal divider 20 at the top of the telescoping poles 30 and hang several vertical dividers from there.

The foregoing discussion of the present invention has primarily been described as the invention relates to practice of softball or baseball pitching. However, the customizability of the size of the device in terms of height and width means that the invention can be used to practice a variety of other sports as well. Because the stanchions 15 are portable and not fixed in the ground, they can be spread as far apart as the user desires. Because the poles 30 are telescoping in some embodiments, the height of the stanchions 15 can be extended or reduced by several feet. Further, because the weight of the base 35 is adjustable in some embodiments, the device can be made more stable when the stanchions 15 are spaced apart and when the pole 30 is extended to increased heights. The adjustability of the weight also helps ensure stability when the object passing through the target zone is large and travelling at a high rate of speed. Additionally, the horizontal dividers 20 and vertical dividers 25 are typically made of a string type material, and thus, the only limit as to the length of the horizontal dividers 20 and vertical dividers 25 is the amount of the material available.

Accordingly, the device can be adapted to several different scenarios. For instance, the device could be used to simulate soccer, hockey, or lacrosse goals. Further, the device could be set up as a target to which a quarterback could practice passing a football, a tennis player could practice serving, or a basketball player could practice passing. These sports and uses are meant to be illustrative and in no way limiting.

### Vertical Divider Embodiment

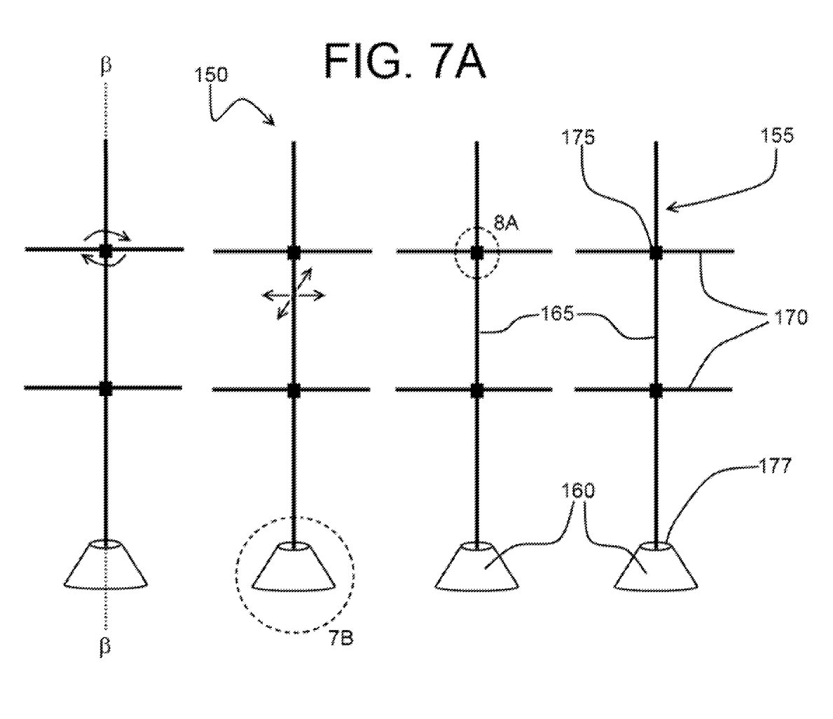

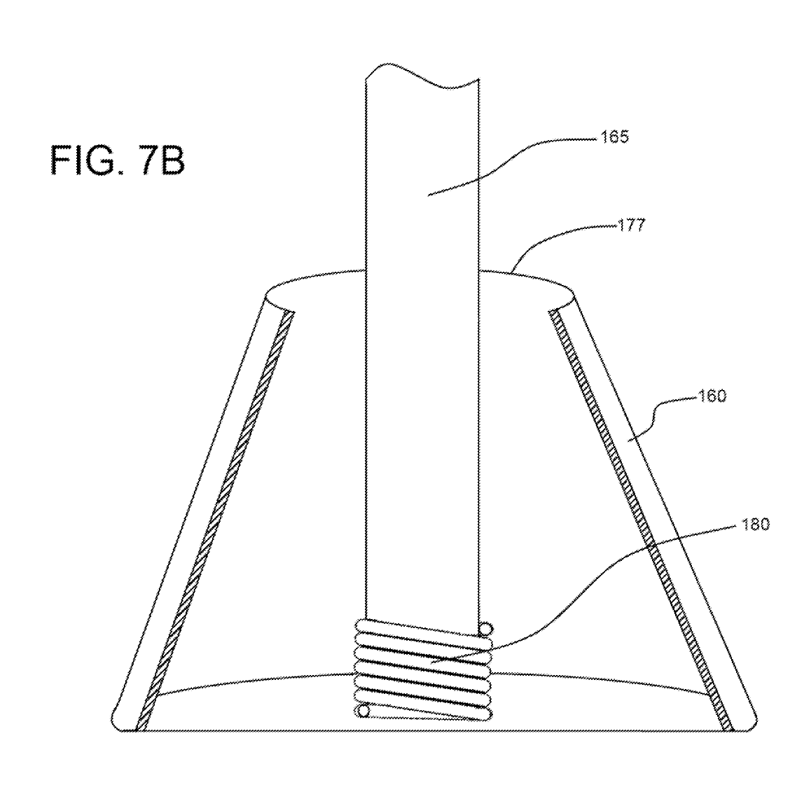

In an alternate embodiment, the horizontal dividers rotate around stationary vertical dividers. As can be seen in FIG. 7A, the pitching trainer 150 is comprised of a plurality of stanchions 155. Each stanchion 155 is comprised of a base 160 and a pole 165. The pole 165 serves as the vertical divider for the strike zone. At various points along the length of the pole 165 are horizontal dividers 170. When a pitched ball comes in contact with the horizontal dividers 170, they will swivel, or rotate, around the longitudinal axis α of the pole 165 at swivel points 175.

As shown in FIG. 7A, the base 160 is frustoconical with an opening 177 at the top of the base. As can be seen in greater detail in the sectional view shown in FIG. 7B, the pole 165 extends through the opening 177 into a cavity on the interior of the base 160. On the bottom interior of the base 160 is a spring 180 that receives the pole 165. The spring 180 is rigidly affixed to the bottom of the base 160.

In operation, a pitcher throws a ball to the strike zone defined by the poles 165 and the horizontal dividers 170. If the ball contacts one of the poles 165, then the spring 180 in the base allows the pole 165 to deflect out of the path of the ball. The size of the opening 177 at the top of the base 160 is larger than the diameter of the pole 165 and so the opening accommodates the pole 165 to deflect in directions. The resiliency of the spring 180 then returns the pole 165 to its upright position. If the ball contacts one of the horizontal dividers 170, then the horizontal divider 170 will swivel or rotate around the longitudinal axis α of the pole 165.

Preferably, the pole 165 and horizontal dividers 170 have a small cross section in relationship with the large openings for the ball to pass through. More preferably, the pole 165 and horizontal dividers have a circular cross section with a diameter of between about 2 mm and about 10 mm with a 5 mm diameter being most preferred. Thin circular rods or pipes help to reduce deflections of a pitched ball that has contacted the pole 165 or horizontal divider 170. Because the poles 165 and horizontal dividers 170 are ideally so thin, they need to be made of a rigid and durable material. The material needs to be rigid so as to avoid sagging, drooping, or bending of the poles 165 and horizontal dividers 170. However, the material cannot be so rigid as to be brittle because then contact with a pitched ball will break the poles 165 or horizontal dividers 170. The inventor recommends using copper or steel tubing, ABS rods, wooden dowels, or bamboo for the poles 165.

The pole 165 can feature a number of preselected points at which to attach the swivel points 175, or the swivel points 175 can provide a means for gripping on to the pole 165. In one embodiment, the swivel points 175 are roller bearings. In another embodiment, the roller bearings have limits that prevent the dividers 170 from rotating more than 90° from the neutral position (i.e., the position of the vertical dividers prior to the pitch). The horizontal dividers 170 attach to the exterior of the bearing, while the interior of the bearing frictionally engages the pole 165, such as by a rubber gasket.

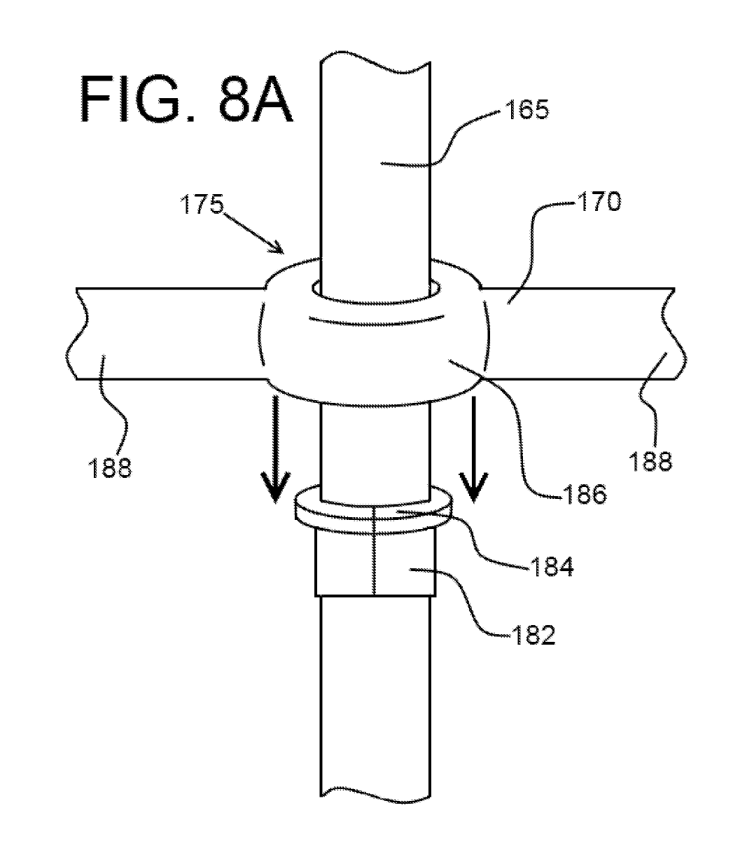

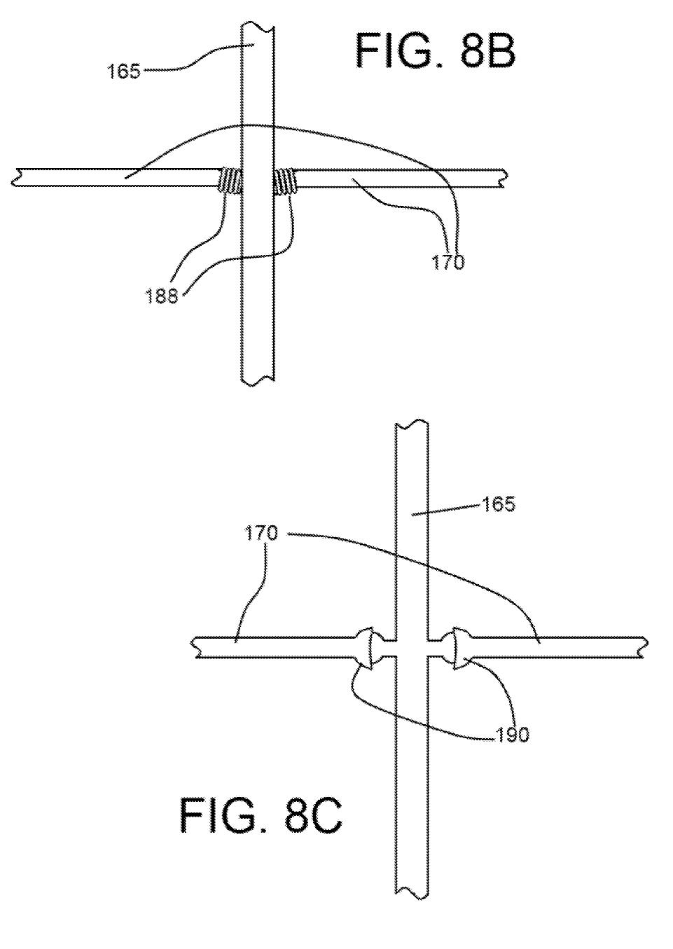

In another embodiment as shown in FIG. 8A, a cuff 182 is snugly fitted to the pole 165. The cuff 182 has a lip 184 on its superior end. The horizontal divider 170 has a central ring 186 that rests on the lip 184. The horizontal divider 170 has arms 188 that are integrally molded or otherwise attached to the ring 186. The user can snap, slide, or otherwise fix the cuff 182 in a desired place. The ring 186 of the horizontal divider 170 is then slid down the pole 165 to rest on the cuff 182. In another embodiment, a pin secures the cuff 182 to the pole 165. In yet another embodiment, the swivel point 175 is comprised of a swivel memory device that returns the divider 170 to the neutral position after a pitched ball causes the divider 170 to rotate around the pole 165. Such swivel memory devices often contain stops to prevent over-rotation and springs or bands to snap the device back to a neutral position.

Additional alternative embodiments are depicted in FIGS. 8B and 8C. FIG. 8B shows a divider 170 attached to the pole 165 via a spring 188. The spring 188 allows the divider 170 to deflect under the force of a pitched ball, and then returns the divider 170 to the neutral position. In FIG. 8C, the divider 170 is made from a pliable material and attached to the pole 165 by a ball and socket joint 190. This configuration allows the divider 170 to deflect under the force of a pitched ball, and the inherent resiliency of the divider 170 allows it to recover to the neutral position.

As depicted in FIG. 7A, four stanchions 155 are utilized; however, more or less stanchions 155 could be used. Also as depicted in FIG. 7A, each stanchion 155 has two horizontal dividers 170. Nevertheless, each stanchion 155 could have more or less horizontal dividers 170, and each stanchion 155 could have a different number of horizontal dividers 170.

### Laser Embodiment

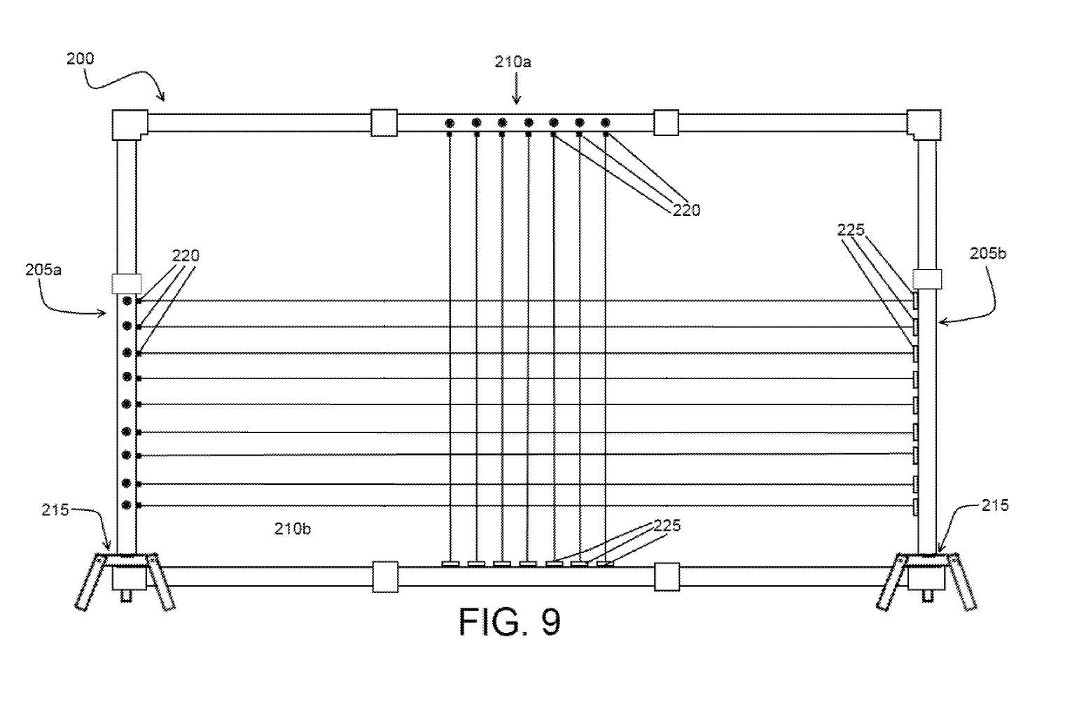

In an alternate embodiment designed primarily for pitching practice, the horizontal dividers 20 and vertical dividers 25 comprise light beams, such as beams of laser light. This laser embodiment 200 can be seen in FIG. 9. The laser embodiment 200 is comprised of a first vertical member 205a and a second vertical member 205b, an upper horizontal crosspiece 210a and a lower horizontal crosspiece 210b, and two bases 215. For the purposes of illustration, the components of the laser embodiment, like the string embodiment, should obstruct the least amount of area around the strike zone as practically possible. Therefore, a suggested height for the first and second vertical members 205a and 205b is six feet. The suggested length of the horizontal crosspieces 210a and 210b are ten feet, or the approximate combined width of both batter's boxes and home plate. Nevertheless, larger or smaller heights can be used for this embodiment of the invention.

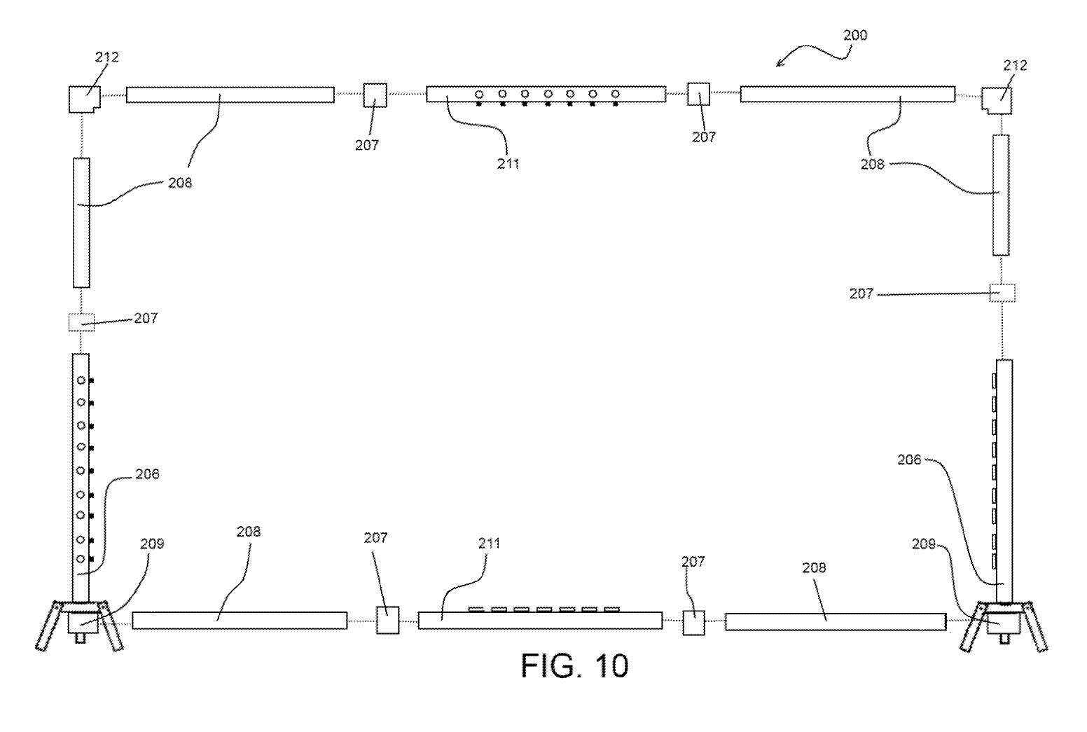

As can be seen in the exploded view of the laser embodiment 200 in FIG. 10, the device is designed to dismantle for increased portability. The vertical members 205a and 205b are made up of three parts: the base portion 206, which features a plurality of laser sensing devices 220, a sleeve 207, and an extender portion 208. The base portion 206 is substantially similar to the base 35 of the previous embodiment except that a weight 60 is not provided on the underside of the base 35. Instead, a coupling 209 designed to receive the lower horizontal crosspiece 210b is provided on the underside of the base portion 206. The horizontal crosspieces 210a and 210b are longer in this illustration and are, thus, comprised of five parts: two extender portions 208, two sleeves 207, and the middle portion 211. Finally, two corner couplings 212 are provided to join the vertical members 205a and 205b with the horizontal crosspieces 210a and 210b.

As shown in FIG. 10, the middle portion 211 and the two sets of extender portions 207 of the horizontal crosspieces 210a and 210b are each thirty-six inches in length. The base portion 206 of the vertical members 205a and 205b are forty-eight inches in length, and the extender portions 207 are twenty inches in length. The sleeves 207, couplings 209, and corner couplings 211 provide joints for each portion and add additional length to the overall vertical height and horizontal width of the device. The joints can be made between the sleeves 207, couplings 209, and corner couplings 211 and the portions in a variety of ways, including, but not limited to, tight frictional engagement, internal gasket seal, and male and female threaded ends. In a preferred embodiment, the portions, sleeves, and couplings will fit together in such a manner so that in assembling the device the lasers and reflectors are automatically aligned. One such joint that could provide this alignment is a pin and locking groove embodiment. The interior of the sleeves and couplings feature a pin and the portions feature a groove into which the pin slides and locks.

As can be seen in FIG. 9, the first vertical member 205a contains a plurality of laser sensing devices 220 that serve as the horizontal dividers. These laser sensing devices 220 can be diffuse, retro-reflective, or through beam. The inventor has found retro-reflective laser sensors to provide a good comprise between accuracy and cost. The second vertical member 205b contains a matching number of reflectors 225. However, if a through beam device is used, the second vertical member 205b will contain a matching number of receivers instead. To provide a complete grid, the upper horizontal crosspiece 210a contains a plurality of laser sensing devices 220 that serve as vertical dividers. The lower horizontal crosspiece 210b contains a matching number of reflectors 225 or receivers. As shown in FIG. 9, each reflector 225 is an individual component, however a long single reflective strip, tape, or ribbon could also be used. The inventor suggests placing the lasers on the upper horizontal crosspiece 210a as it less likely to receive repeated hits by pitched balls than the lower horizontal crosspiece 210b; however, the laser sensing devices 220 could be placed on the lower horizontal crosspiece 210b.

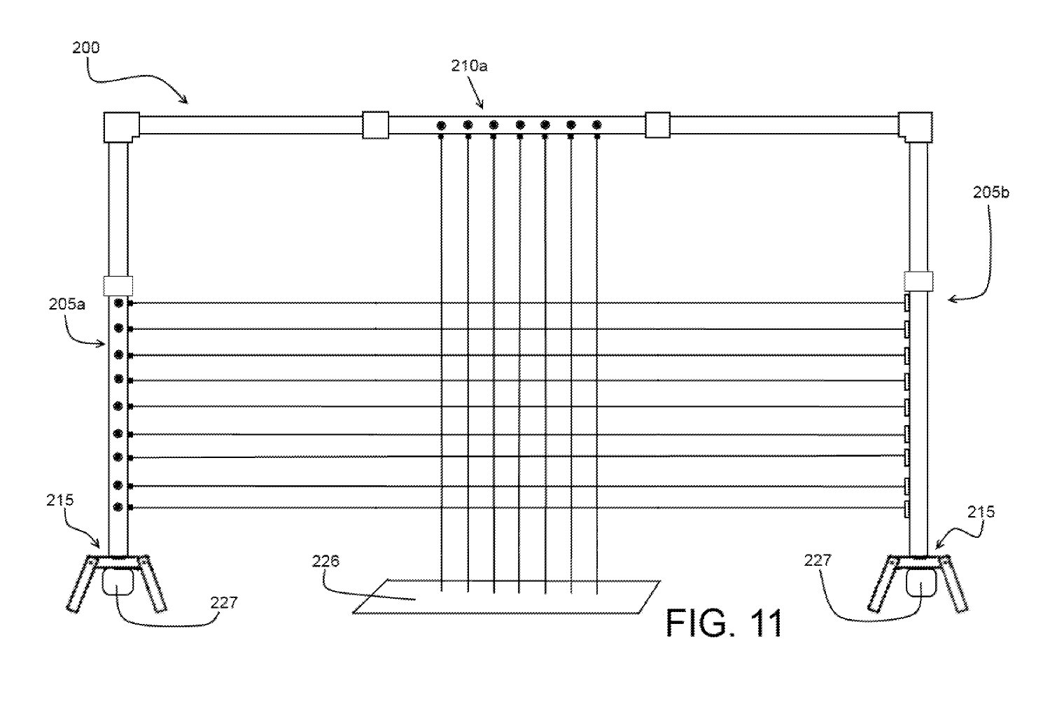

A modified version of the laser embodiment 200 is shown in FIG. 11. In this version, the lower horizontal crosspiece 210b is replaced with a mat 226 of reflective material. The mat 226 provides a surface that is flatter to the ground, which is less likely to cause a pitched ball to deflect into the catcher or the device. The mat 226 is made of reflective material so as to reflect the laser beams back to the laser sensing device 220. Since there is no lower horizontal crosspiece between the bases 206 to provide support for the laser embodiment, weights 227 are added below the bases 206. The weights 227 stabilize the device during operation, such as if the device is struck by a pitch or is used on a windy day.

A typical, commercially available retro-reflective laser sensor features both the laser and receiver in the same module. A suitable retro-reflective laser is the efector200 available from IFM Electronic GMBH, located in Essen, Germany.

The lasers should intersect and form a grid that substantially coordinates to a strike zone. The width of a strike zone as defined by applicable rules is constant and corresponds the width of home plate; however, individual umpires have been known to call wider or narrower strike zones. The height of the strike zone is defined in such a way that it varies by player. According to fastpitch softball rules available from the NCAA, the vertical component of the strike zone is from the bottom of the batter's sternum down to the top of the batter's knee when the batter is in her natural batting stance. Thus, the height depends on the height and batting stance of the batter. For the sake of illustration, the vertical component of the strike zone will be defined to be two and a half feet beginning one foot and three inches off the ground. Thus, the vertical center of the strike zone will be 2.5 feet off the ground. The vertical position of the strike zone corresponds to the placement of the middle laser sensing devices 220 and reflectors 225 on the first and second vertical support members 205a and 205b.

A standard twelve inch softball has a diameter of approximately 3.82 inches. Therefore, the laser sensing devices 220 on the first vertical support member 205a and the upper horizontal crosspiece 210a should be placed approximately 3.75 inches apart to ensure that a ball travelling through the strike zone will contact at least two lasers. The reflectors 225 on the second vertical support member 205b and the lower horizontal crosspiece 210b should correspond to a laser sensing device 220 placement.

The placement of the laser sensing devices 220 begins at the horizontal and vertical midpoints. For this illustration, the first vertical laser sensing device 220 will be 2.5 feet off the ground on the first vertical member 205a. The first horizontal laser sensing device 220 is placed at the midpoint of the upper the horizontal crosspiece 210a, which in this illustration is at a horizontal length of five feet. The next two laser sensing devices 220 are placed 3.75 inches to the top and bottom of the first vertical laser sensing device and to the left and right of the first horizontal laser sensing device. The following laser sensing devices are then placed at 7.5 inches and 11.25 inches to the top and bottom and left and right of the midpoint sensors. These seven sensors cover a length of 22.5 inches. On the horizontal crosspiece, this length covers the width of home plate plus a pitch that “paints the black,” i.e., a ball that crosses the black trim around the plate. Because the vertical portion of the strike zone in this illustration was defined to be thirty inches in length, two additional sensors are placed fifteen inches to the top and bottom of the midpoint sensor. In a separate embodiment, the first vertical support 105a and the upper horizontal crosspiece 210a feature preformed slots for additional laser sensing devices 220 to be added or moved. The laser embodiment 200 could come preconfigured to receive additional laser sensing devices 220, or the individually sold laser sensing devices 220 could be configured to connect to the laser embodiment 200. In that way, the grid defined by the lasers could be expanded so that the pitcher could practice making pitches outside the strike zone or so that a larger strike zone could be simulated.

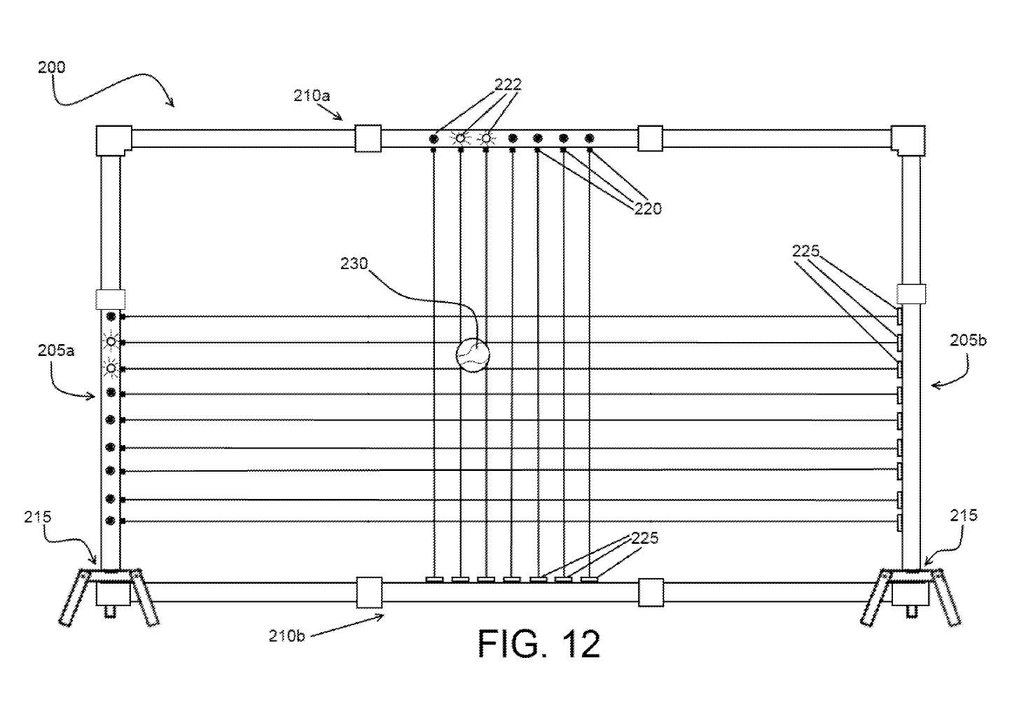

The laser sensing devices 220 in one embodiment are connected to LED lights 222. As a pitched ball passes through the strike zone, LEDs 222 on the vertical members 205a and 205b and the horizontal crosspieces 210a and 210b will light up, giving the pitcher a coordinate location. A pitch in the strike zone will always provide feedback from at least two lasers because the spacing of the lasers ensures that at least one horizontal beam and at least one vertical beam are crossed. FIG. 12 depicts a ball 230 travelling through the strike zone and the resultant coordinate LED indicators.

In another embodiment, sound indicators are also used, with a distinct tone or distinct tune played depending on which laser detector has been triggered. In yet another embodiment, because the laser beams are invisible to the naked eye, strings are strung near each laser beam so as to provide a visible reference for each beam. Alternatively, a second low powered laser beam is installed in another embodiment. In still another embodiment, a vapor dispenser provides small puffs of vapor to make the beams visible but not so much vapor as to obstruct the catcher's view. A variety of vapor dispensers is suitable for this application, including water misters, fog machines, and haze machines. Preferably, a haze machine is utilized because the vapor produced is less obtrusive and because the vapor tends to dissipate slower. If the device is set up on a ball diamond, then the dirt from the diamond can also be scattered by the user. The vapor dispenser can be an integral part of the laser embodiment, an after purchase modular attachment, or a stand-alone device.

Like the previous embodiment, the laser embodiment 200 should be made of lightweight and durable materials. Such materials as hardened aluminum and titanium alloys, stainless steel, composites such as carbon fiber, polycarbonate, and polyvinylchloride are all suitable; although other materials with similar properties are also suitable. Additionally, the materials should be rigid so as to avoid sagging in the middle. Sagging could prevent accurate readings from the laser by misdirecting the reflected beam.

As depicted in FIG. 9, the diameter of the vertical members 205a and 205 b and the horizontal crosspieces 210a and 210b are roughly equal. The first vertical member 205a and the upper horizontal crosspiece 210a house the components to power the laser sensing devices 220 and the LEDs 222. Such components might include a battery pack, central processing unit, connecting components, and mounting components. Additionally, some of these components, such as the battery pack and/or the central processing unit, could be located in the bases. Access panels could optionally be provided to change or charge the battery pack. Further, an ON/OFF switch should be provided on the side of the first vertical member 205a and the upper horizontal crosspiece 210a that is opposite of an incoming pitch so as to avoid contact from a pitch. The second vertical member 205b and the lower horizontal crosspiece 210b do not house any electrical components and can, therefore, be made of a solid material or of a thinner diameter. However, should a through beam laser be used, then those components would need to house components necessary to power the receivers.

The laser embodiment 200 could also feature a means to record the location of pitches. Since at least two lasers will be touched by any pitched ball in the strike zone, a program could record the coordinates of each pitch passing through the zone. The data collected by the laser embodiment could be wireless exported via WiFi or Bluetooth or exported via a USB cable or flash drive to a computer, laptop, tablet, or smartphone. In that way, the pitcher or a coach could track the location of every pitch and analyze the pitcher's command of her pitches over time.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112(f) unless and until such claim limitations expressly use the phrase “means for” followed by a statement of function void of further structure.

The present methods can involve any or all of the steps or conditions discussed above in various combinations, as desired. Accordingly, it will be readily apparent to the skilled artisan that in some of the disclosed methods certain steps can be deleted or additional steps performed without affecting the viability of the methods.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

The embodiment of the invention in which an exclusive property right or privilege is claimed is defined as follows:

1. A sports training device, comprising:
at least two stanchions, wherein the stanchions are spaced a horizontal distance apart from each other and wherein the stanchions are adjustable vertically and are portable;
a plurality of horizontal dividers, wherein the plurality of horizontal dividers span between the at least two stanchions; and
a plurality of vertical dividers, wherein the plurality of vertical dividers depend from at least one of the plurality of horizontal dividers and wherein the plurality of horizontal dividers and the plurality of vertical dividers overlap to define a plurality of zones.

2. The device of claim 1, wherein the plurality of horizontal dividers and the plurality of vertical dividers are movable relative to each other such that movement of the plurality of horizontal and vertical dividers changes dimensions of the plurality of zones.

3. The device of claim 1, wherein a portion of the plurality of horizontal dividers and a portion of the plurality of vertical dividers that define the plurality of zones are made of a highly visible material.

4. The device of claim 1, wherein the at least two stanchions further comprise a base with three legs defining a tripod, wherein the three legs each have a distal end designed to engage ground.

5. The device of claim 4, wherein the distal ends of the three legs of the base defining a tripod fold upwardly and inwardly towards a telescoping region of the stanchion.

6. The device of claim 1, wherein the at least two stanchions further comprise a weight placed on the end of the stanchion proximal to ground.

7. The device of claim 6, wherein the weight is removable.

8. The device of claim 6, wherein the weight is between three and ten pounds.

9. The device of claim 1, wherein the plurality of horizontal and vertical dividers are elastic cords.

10. The device of claim 9, wherein the elastic cords are between 1 and 10 mm in thickness.

11. The device of claim 1, wherein the plurality of horizontal and vertical dividers are made of at least one highly visible color.

12. The device of claim 11, wherein the plurality of horizontal and vertical dividers have one highly visible color on a first side and a second highly visible color on a second side opposite the first side.

13. The device of claim 1, wherein the plurality of vertical dividers further include a hanging weight.

14. The device of claim 1, wherein each of the at least two stanchions features a base, wherein the base has at least one wheel.

15. A strike zone detection device, comprising:
a first vertical support member, wherein the first vertical support member contains a plurality of horizontally directed laser sensing devices;
a second vertical support member, wherein the second vertical support member contains a plurality of reflectors;
an upper horizontal crosspiece, wherein the upper horizontal crosspiece contains a plurality of vertically directed laser sensing devices; and
a lower horizontal crosspiece, wherein the lower horizontal crosspiece contains a plurality of reflectors, and wherein the horizontally and vertically directed lasers intersect to define a strike zone.

16. The device of claim 15, wherein the horizontally and vertically directed laser sensing devices are retro-reflective lasers.

17. The device of claim 15, wherein the vertically directed laser sensing devices are spaced between 2.5 inches and 4.5 inches apart from each other and wherein the horizontally directed laser sensing devices are spaced between 2.5 inches and 4.5 inches apart from each other.

18. The device of claim 15, wherein each vertical and horizontal laser sensing device is in electronic communication with an LED indicator light and wherein a LED indicator light responds to a pitched ball that crosses in front of any of the vertical and horizontal laser sensing devices.

19. The device of claim 15, further comprising a data recording device, wherein said data recording device is configured to:
receive a signal from each horizontally and vertically directed laser that comes in contact with a pitched ball;
translate received signals from the plurality of horizontally and vertically directed laser sensing devices into coordinates representing a location of the pitched ball within the strike zone;
record the coordinates as data on a computer readable medium; and
export the data.

20. The device of claim 15, wherein the lower horizontal crosspiece is a mat that rests on ground.
